(19) United States
(12) Patent Application Publication
(10) Pub. No.: US 2003/0132565 A1
(43) Pub. Date: Jul. 17, 2003

(54) Carrier tape embossing apparatus clamp

(76) Inventor: Donald B. Hunter, Ontario, CA (US)

Correspondence Address: ALBERT O COTA, 5460 WHITE OAK AVE, SUITE A-331, ENCINO, CA, 91316, US

(21) Appl. No.: 10/045,764

(22) Filed: Jan. 15, 2002

(51) Int. Cl. B25B 1/00

(52) U.S. Cl. 269/254 R

(57) ABSTRACT

A carrier tape embossing apparatus clamp for linear movement and retention of a carrier tape (48) during its embossing process which consists of a pair of opposed clamp bodies (20) with a radial cavity (30) on the top, a leaf spring (38) covering the top, a spring retainer (40) attached to the top for holding the spring on one side, and a pair of actuating rods (44) disposed within each radial cavity. The leaf spring (38) bends upward away from the body when each respective rod is rotated as the rod has a flat surface and is not eccentric with the cavities. The carrier tape (48) is gripped between the clamp bodies and the leaf springs with linear actuating means propelling the clamp along with its retained tape in a linear direction through appropriate stations in a carrier tape embossing apparatus. The tape is released from between the clamp body (20) and the leaf spring (38), when the embossing apparatus returns the clamp body (20) to its original at-rest position. The apparatus urges the tape forward when clamped on the edges and propels the tape sequentially through the carrier tape heating forming and piercing stations. The apparatus creates the necessary appropriate timed sequence for the retaining and linear propulsion.

### TECHNICAL FIELD

The present invention pertains to the general filed of high speed carrier tape forming machines and more particularly to a clamp mechanism that holds the tape taught from both sides and causes the tape to be moved through the various stations in the tape forming machine.

### BACKGROUND ART

Previously, many types of tape holding devices have been used in high speed tape forming machines to provide an effective means of performing necessary operations during the manufacture of component holding carrier tape.

A search of the prior art did not disclose any patents that possess the novelty of the instant invention, however the following U.S. patents are considered related:

| U.S. Pat. No. | Inventor | Issue Date |
|---|---|---|
| 6,270,614 | Naito, et at. | Aug. 7, 2001 |
| 6,179,127 | Kato, et at. | Jan. 30, 2001 |
| 6,105,783 | Sato | Aug. 22, 2000 |
| 5,800,772 | Kurasawa | Sep. 1, 1998 |
| 5,738,816 | Tidemann, et al. | Apr. 14, 1998 |
| 5,499,771 | Hayashi | Mar. 19, 1996 |

Naito, et al. in U.S. Pat. No. 6,270,614 teaches a method of fabricating component holding carrier tape by injection molding and joining tape sections together to form the tape.

U.S. Pat. No. 6,179,127 issued to Kato, et al. is for carrier tape that is formed with a die, which creates corner shelf sections in such a manner as to be expanded outwardly from the opening. Thus, allowing the shelf sections to support the bottom of another tape when semiconductors are disposed within a series of pockets located on the carrier tape.

Sato in U.S. Pat. No. 6,105,783 discloses a embossed carrier tape with protective ribs located between adjacent device holes. The patent also includes a method to hold the electronic components in place within the tape.

Kurasawa in U.S. Pat. No. 5,800,772 teaches a method for producing an embossed carrier tape consisting of preheating and moving the tape to a convex mold which is urged firmly against a drum by a hold down roller to form pockets. The tape is then cooled to normal temperature and removed from the drum while the tape is disconnected from a vacuum source and being transferred to a take-up reel.

U.S. Pat. No. 5,738,816 issued to Tidemann, et al. Discloses a method of making a component carrier tape using an advancement mechanism. The tape has a strip portion for receiving the advancement mechanism. The device thermoforms pockets and protuberances are cut to form holes for engagingly receiving the advancement mechanism.

For background purposes and as indicative of the art to which the invention is related reference may also be made to the U.S. Pat. No. 5,499,771 issued to Hayashi.

### DISCLOSURE OF THE INVENTION

Carrier tape embossing machines have been developed and are in presently used to produce carrier tape for holding various components such as semiconductor and other electronic components to allow them to be automatically placed on circuit boards, or the like, during the circuit board manufacturing process. Each machine is specifically developed for distinct components at various spacing which is governed by the actual size and configuration of the part. In most cases the tape is formed with pockets embossed into the tape itself with indexing holes on the edge and in some cases with a hole in the bottom of the pocket to identify that the part is in place and that the part is properly oriented. The problem that has plagued the industry for some time is that the tape is conventionally pulled through various stations from a finished end. Since the stations require heat to form the tape into pockets, the tape shrinks slightly when pneumatic pressure is applied to expand the heat-softened tape into a die. The shrinkage leaves the tape's edges uneven and wrinkled, which can cause problems with the manufacturing machine, thus, creating stoppages and unnecessary obstacles during the manufacturing process. Heretofore the tape processed on prior art machines has been held loosely at the edges between two grooves, as shown in FIG. 14 which provides little or no control of the edges.

The primary object of the invention is to overcome the above problems without any waste by gripping both sides of the tape simultaneously and retaining it sequentially through the various stations in the embossing apparatus. This novel feature is accomplished by threading the tape through a recess between a clamp body and a leaf spring which are located on each side and projecting the clamp forward while the tape is retained therebetween and by releasing tension on the spring when the clamp is returned to its original position.

An important object of the invention is that if the tape is held taut at both edges, when the tape is heated, it is formed perfectly into pockets in the forming station and the holes are accurately punched in the piercing station yielding a uniform tape surface.

Another object of the invention is that the width of the tape may be changed without the necessity of replacing the entire clamping assembly.

Still another object of the invention is the cost efficiency as no tape is wasted if it is necessary to slit the tape edges to circumvent the anomaly of the edges.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a partial isometric view of a typical high speed carrier tape embossing apparatus that incorporates the clamping device in its preferred embodiment.

FIG. 2 is a cross sectional view taken along lines 2-2 of FIG. 1 illustrating the tape held on each edge in the preferred embodiment of the clamping device.

FIG. 3 is a flow chart of a typical high speed carrier tape embossing apparatus that utilizes the clamping device in a procedural sequence.

FIG. 4 a block diagram of the stages utilized in a typical high speed carrier tape embossing apparatus showing the interface with the invention.

FIG. 5 is a partial isometric view of the clamping device with individual sections attached together and the actuating rods penetrating the radial cavities, with directional arrows indicating the control of tape movement and rod rotation in the preferred embodiment.

FIG. 6 is a diagram of the movement direction of the clamping device created by the linear actuating means in a retracted position with the clamp opened thus permitting the tape to remain stationary.

FIG. 7 is a diagram of the movement direction of the clamping device created by the linear actuating means in an extended position with the clamp closed, gripping the tape therebetween.

FIG. 8 is a cross sectional view taken along lines 8-8 of FIG. 6.

FIG. 9 is a cross sectional view taken along lines 9-9 of FIG. 7.

FIG. 10 is a partial isometric view of a single assembled section of the clamp in the preferred embodiment completely removed from the carrier tape embossing apparatus for clarity.

FIG. 11 is an exploded partial isometric view of a single section of the preferred embodiment illustrating all of the related elements.

FIG. 12 is a cross sectional view taken along lines 12-12 of FIG. 10 with the leaf spring in a closed attaching position.

FIG. 13 is a cross sectional view taken along lines 12-12 of FIG. 10 with the leaf spring in the bent upward open attaching position.

### BEST MODE FOR CARRYING OUT THE INVENTION

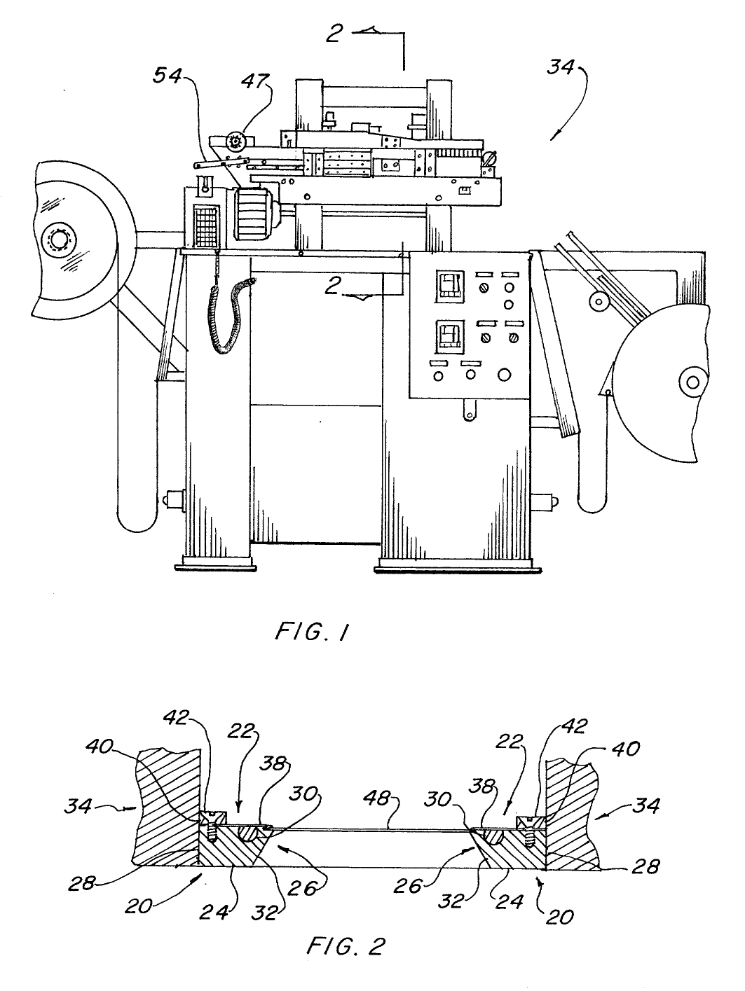

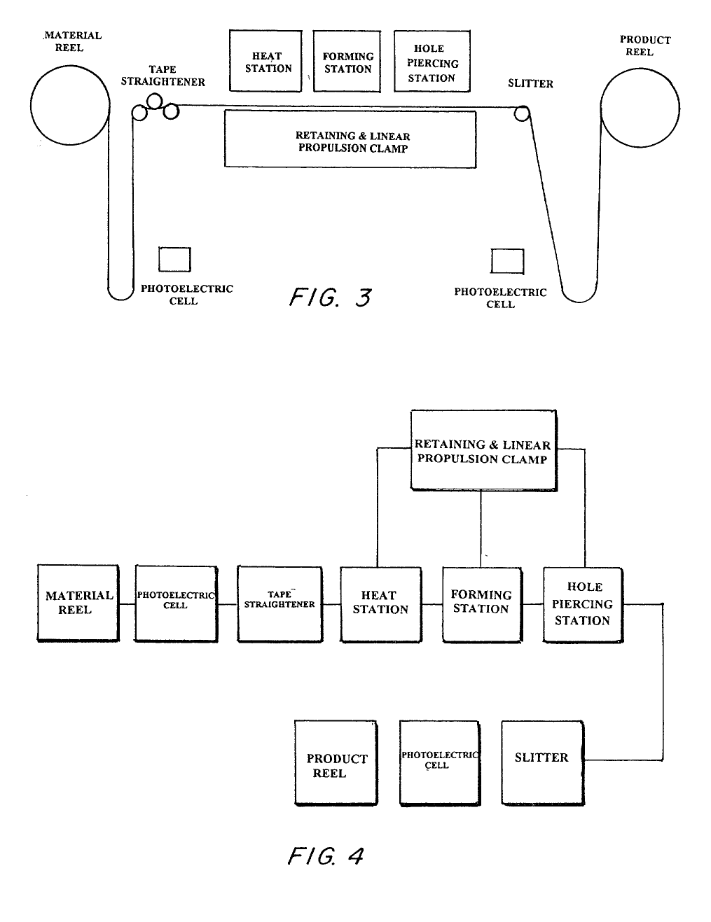

The best mode for carrying out the invention is presented in terms of a preferred embodiment, as shown in FIGS. 1 thorough 13, which comprises a tape clamp for use in the manufacturing of an embossed carrier tape. The tape clamp provides both linear propulsion and retention of a tape during its embossing process in a machine tool. A tape embossing apparatus 34 is illustrated in FIG. 1, and the process and interrelationship with the clamp is schematically depicted in FIG. 3, with the block diagram, shown in FIG. 4, again outlining its functional association. The type of apparatus depicted in the above figures is only representative, as other apparatus types may use the clamp, and further this type of apparatus may be made in a myriad of styles and sizes depending upon the shape and specific requirements of the type of tape and the electronic devices that the tape is ultimately mandated to retain and transport.

FIG. 2 depicts in cross section the location of the clamp relative to the apparatus and illustrates its utilization in pairs with the tape held in between by its edges. In detail the invention in the preferred embodiment consists of a pair of opposed clamp bodies 20 each having a top 22, a bottom 24, a first side 26 and a second side 28 with a radial cavity 30 located within the top. The body 20 is basically in a rectangular shape and is made of steel, with the first side 26 of each clamp body having a bevel 32 to permit clearance with the carrier tape embossing apparatus 34. Threaded mounting holes 36 are provided on the second side 28 to attach the body 20 to the machine or apparatus.

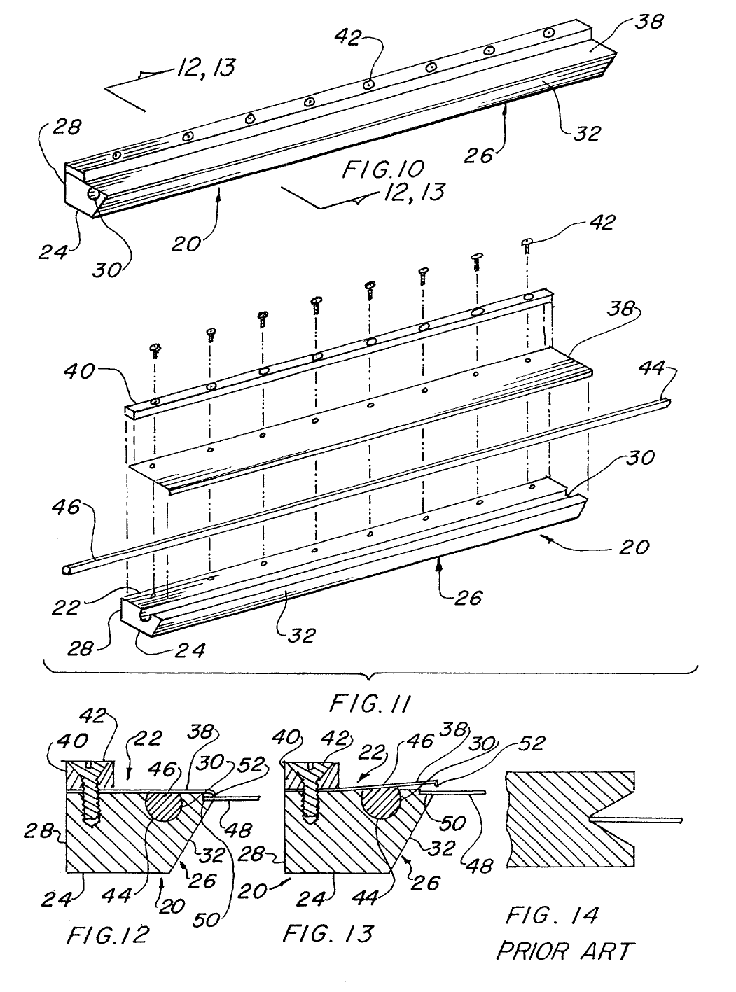

A leaf spring 38, is juxtaposed on the top 22 of the body 20, completely covers each body top and therefore directly over the radial cavity 30, as shown in FIGS. 2, 5 and 8-13. The leaf spring 38 may be made of stainless steel or preferably a spring steel. The thickness may vary as to the size of the tape that is to be manufactured, however it has been found that a thickness of from 0.012 to 0.016 inches (0.305 to 0.406 millimeters) has been proven to be optimum for a tape that is 0.013 inches (0.330 mm) thick starting at essentially 1.875 inches (47.625 mm) wide.

A spring retainer 40, which is attached to a portion of the top 22 of each clamp body 20, and is juxtaposed with the leaf spring 38 for holding the spring on one side, permits the spring to be urged away from the body, as shown in FIGS. 8 and 13. The retainer 40 is fabricated of steel and a plurality of threaded fasteners 42 attach each spring retainer 40 to its respective clamp body 20, as shown in FIGS. 8, 9, 12 and 13.

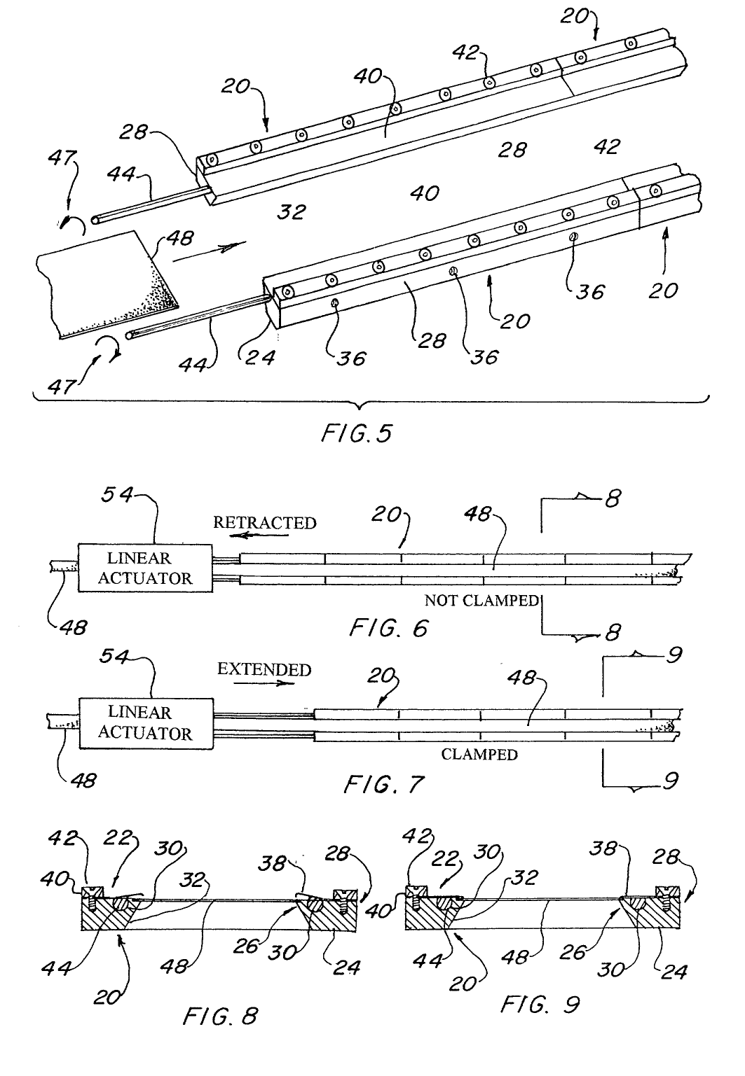

A pair of round actuating rods 44 are disposed within the radial cavities 30 on the clamp bodies 20. Each rod 44 has a flat surface 46 contiguous with the leaf spring 38 such that the leaf spring 38 bends upward away from the clamp body 20 when each respective rod 44 is rotated, as the edges of the flat surface of each rod 44 are eccentric with each cavity 30. This action is depicted in FIGS. 8 and 13, with FIG. 5 illustrating the rotational direction. The actuating rod flat surface 46 is from 0.48 to 0.52 times the basic diameter of the rod 44 in order to achieve the requisite movement of the leaf spring 38 with the geometry shown in the drawings. Depending on the requirement, this relationship may change in other configurations of the finished carrier tape.

The carrier tape embossing apparatus clamp further comprises actuating rod rotating means 47 for revolving each rod 44 simultaneously in an opposite direction. This action retains the tape between the clamps 20 when propelling the tape in a linear direction and, releasing the tape when linear actuating means returns the clamps 20 to their original at rest position such that the tape moves in one direction sequentially through the carrier tape embossing apparatus. The actuating rod rotating means 47 may be a pneumatic cylinder with an attached lever arrangement, an electric solenoid or any other rotational device that may be controlled at a precise timed sequence. The direction of rotation is depicted in FIG. 5, and a pneumatic solenoid is shown in FIG. 1.

A carrier tape 48 is horizontally positioned and gripped between the clamp bodies 20 and the leaf springs 38, as depicted in FIGS. 2, 8 and 9. This tape 48 is generally made of a thermoplastic such as mylar, and conventionally has a thickness of 0.013 inches (0.330 mm) thick when starting the process as its base thickness changes as the pockets are formed by stretching into the molds under pneumatic pressure after heating. The edge of the tape 48 is secured in between the pair of clamp bodies 20 and leaf springs 38 with tape retaining means in the form of a notch 50 located on a corner of the top 22 and the first side 26 of the clamp body 20. The leaf spring has a downward depending lip 52 that overlaps and impinges on the notch 50 when at rest, thus creating spring pressure onto the edge of the carrier tape 48. This gripping action holds the tape taut between the clamp bodies 20 as the tape travels through the tape embossing apparatus 34, as shown in FIGS. 2 and 9. Preferably, the tape 48 is gripped on each side a distance of from 0.020 to 0.030 inches (0.508 to 0.762 millimeters).

Linear actuating means are included in the invention for moving the clamp 20 along with its retained tape 48 in a linear direction through appropriate stations in the carrier tape embossing apparatus 34. The linear actuating means also return the clamp 20, when the tape 48 is released from between the clamp body 20 and the leaf spring 38, to its original at-rest position within an appropriate timed sequence. This action moves the tape sequentially through the carrier tape embossing apparatus 34, with the linear actuating means comprising a linear actuator 54 in the form of a linear electric motor, a pneumatic cylinder including a reversing lever, or the like. The movement and directional indication of the extended and retracted clamp is pictorially indicated in FIGS. 6-9, with the sequence of the various stations shown in FIGS. 3 and 4 corresponding with the movement of the clamp.

The clamp body 20 is sectionalized to increase its flexibility for use in various types of carrier tape embossing machines or apparatus 34. Each section is attached to the machine 34 with fasteners (not shown), through the threaded mounting holes 36 to complete the clamp along with its linear propulsion and retention.

It should be noted that FIGS. 3 and 4 show a typical arrangement of a carrier tape embossing machines or apparatus with its material reel, photoelectric cells, straightener, heat forming and hole piercing stations, as well as a slitter and a product reel, all of which are interrelated with the invention in its preferred embodiment as a retaining and linear propulsion clamp.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

1. A carrier tape embossing apparatus clamp for linear propulsion and retention of a tape during its embossing process comprising:
a) a pair of opposed clamp bodies each having a top, a bottom, a first side and a second side, and a radial cavity located within the top,
b) a leaf spring completely covering each body top directly over the radial cavity,
c) a spring retainer attached to a portion of the top of each clamp body, and juxtaposed with the leaf spring for holding the spring on one side and yet permitting the spring to be urged away from the body,
d) a pair of round actuating rods each having a flat surface thereon, disposed within the radial cavities on the clamp bodies, with their flat surface contiguous with the leaf springs such that the leaf spring bends upward away from the body when each respective rod is rotated as the edges of the flat surface are eccentric with the cavities,
e) a carrier tape horizontally positioned and gripped between the clamp bodies and the leaf springs,
f) tape retaining means for maintaining the tape edge securely in between the pair of clamp bodies and leaf springs, and
g) linear actuating means for moving the clamp along with its retained tape in a linear direction through appropriate stations in the carrier tape embossing apparatus and returning the clamp, when the tape is released from between the clamp body and the leaf spring, to an original at-rest position within an appropriate timed sequence to move the tape sequentially through the carrier tape embossing apparatus.

2. The carrier tape embossing apparatus clamp as recited in claim 1 wherein said first side of each clamp body further comprises a bevel to permit clearance with a carrier tape embossing apparatus.

3. The carrier tape embossing apparatus clamp as recited in claim 1 wherein said leaf spring is made of spring steel and has a thickness of from 0.012 to 0.016 inches (0.305 to 0.406 millimeters).

4. The carrier tape embossing apparatus clamp as recited in claim 1 further comprising a plurality of threaded fasteners which attach each spring retainer to the respective clamp body.

5. The carrier tape embossing apparatus clamp as recited in claim 1 wherein said round actuating rod flat surface is from 0.48 to 0.52 times its diameter.

6. The carrier tape embossing apparatus clamp as recited in claim 1 further comprising an actuating rod rotating means for:
a) revolving each rod simultaneously in an opposite direction to retain the tape between the clamps when moving the tape in a linear direction, and
b) releasing the tape when the linear actuating means returns to its original at rest position such that the tape moves in one direction sequentially through the carrier tape embossing apparatus.

7. The carrier tape embossing apparatus clamp as recited in claim 1 wherein said tape retaining means further comprises, said body having a notch located on a corner of the top, and the first side and the leaf spring having a downward depending lip that overlaps and impinges on the notch when at rest, thus creating spring pressure onto the edge of the carrier tape, which holds the tape taut between the clamp bodies as it travels through the tape embossing apparatus.

8. The carrier tape embossing apparatus clamp as recited in claim 1 wherein said tape is gripped on each side a distance of from 0.020 to 0.030 inches (0.508 to 0.762 millimeters).

9. The carrier tape embossing apparatus clamp as recited in claim 1 wherein said linear actuating means further comprises a linear electric motor.

10. The carrier tape embossing apparatus clamp as recited in claim 1 wherein said linear actuating means further comprises a pneumatic cylinder and a reversing lever.

11. The carrier tape embossing apparatus clamp as recited in claim 1 wherein said clamp body is sectionalized to increase its flexibility for use in various types of carrier tape embossing machines.
